(19) United States
(12) Patent Application Publication
(10) Pub. No.: US 2003/0204562 A1
(43) Pub. Date: Oct. 30, 2003

(54) System and process for roaming thin clients in a wide area network with transparent working environment

(76) Inventor: Gwan-Hwan Hwang, Hsinchu (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/135,983

(22) Filed: Apr. 29, 2002

(51) Int. Cl. G06F 15/16

(52) U.S. Cl. 709/203; 709/226

(57) ABSTRACT

A multiple-application-server architecture model for thin-client/server (denoted MAS TC/S) is provided to allow users with thin-client devices to roam around a wide area network while experiencing transparent working environment. The MAS TC/S system includes major components of a display protocol, a multiple-application-server network, an application-server discovery protocol and a distributed file system. The application-server discovery protocol identifies the most appropriate application server for a thin-client device to connect to. The distributed file system includes a data-mining-based intelligent prefetching mechanism allowing achieving a working environment with access, location, and mobility transparencies in an efficient way for prompt service.

### FIELD OF THE INVENTION

The present invention relates to a thin-client/server architecture, and more particularly, to a multiple-application-server architecture for thin-client/server allowing users with thin-client devices to roam around a wide area network whilst experiencing transparent working environment.

### BACKGROUND OF THE INVENTION

Thin-client/server computing model is growing rapidly due to low cost and rapid deployment of applications running at the server side, or so-called server-based computing. The server-based computing allows corporations to gain more control over applications by managing them at the server infrastructure instead of at the desktops. Multi-user thin-client/server computing model takes this one stage further, by delegating running applications to solely on a server. All the applications and data are deployed, managed, and supported on the server. Accordingly client devices merely monitor inputs from mice and keyboards, pass them to the server, and wait for the displays returned by the server.

In a conventional thin-client/server computing model, as shown in FIG. 1, one or more multiple thin-client device 1a is connected to an application server 1b. A limited local transparent working environment is provided to users regardless of what type of thin-client devices being used, and regardless of where the thin-client devices stand—as long as these thin-client devices are linked to the exact local area network where the application server belongs.

A display protocol is built for the communication between the thin-client devices and application server. The display protocol is highly optimized for specific software APIs to reduce their bandwidth requirements; e.g., X protocol, independent computing architecture (ICA) protocol, remote desktop protocol (RDP), and stateless low-level interface machine (SLIM) protocol.

The thin-client devices gather inputs from users in the form of mouse clicks and keystrokes, send them to the application server for processing, and collect screen updates as the response from the application server.

The application server provides a centralized maintenance environment since all the applications are installed and executed on it. The information-systems department of a corporation can deploy and update the applications instantly without ever needing to “touch” every desktop or PC, which thereby dramatically reduces the cost of upgrading and deploying applications. Users also have access to applications and data within a limited local area network, which increases their productivity; and security is also enhanced because all data are maintained on the application server. In addition, the thin-client/server computing model increases sharing of computing and memory resources on the application server.

The thin-client device can be realized using low-cost, diskless computers with the display protocol built into their ROMs. They need only the following hardware components: keyboards, monitors, serial or network interfaces, high-speed serial ports, and bi-directional parallel ports. Examples of proprietary thin-client devices include X terminal, SLIM console, and ICA's windows-based terminal. An ordinary personal computer, workstation, TV set top box, PDA (personal digital assistant), or cellular phone can also be used as a thin-client device by installing appropriate software that supports the display protocol.

The conventional thin-client/server model is restricted in use because it assumes a single-application-server network in which each client device always connects to the same application server. Since all the user's data and application software are stored on the same single application server, a user could only roam within a restricted area (the local area network, or LAN) where this application server links in meeting the requirement of providing the user with a transparent working environment.

Only when each thin-client device is always connected to a single application server that transparent access for users to their proprietary files and applications can be achieved. Besides, since a response time is determined by network bandwidth and load on the application server, a desirable response time will be realized only if the thin-client device is attached in the same local area network with the application server. However, this further limits the number of thin-client devices.

The disadvantages and inconvenience of the traditional thin-client/server system come from restriction of a user's data being stored in a single application server. If a user is going to leave the local area network where the application server links, he/she will need to assign an application server standing in the location where he/she is traveling to. This may involve certain environment setting which the user could be unfamiliar with, and moreover, according to conventional process, all the user's proprietary data will need to be transmitted to the assigned application server, which not only leads to requirement of very large storage capacity for every application server but also consumes tremendous bandwidth during data transfer.

Taking a user working in a transnational corporation as example: if the user is going to travel from his/her office located in California to Japan, some problems may be encountered according to the conventional ways. The user will encounter hardly bearable long response time if trying to connect to the application server located in California from Japan.

In another circumstance, some corporations/organizations may try to replicate each user's data and application software on all application servers. However, full replication of the user's data will usually cause a prohibitively high cost: considering an enterprise with 10,000 users whose individual disk quota is 100 MB—to fully replicate user's data, each application server needs to allocate 10,000×100 MB=1,000 GB of disk storage!

In addition to the huge disk space requirement, synchronizing a user's data may consume much of the network bandwidth. For example, updating a 10 MB file would cause a total of 10,000×10 MB=100 GB of data to be routed among all the application servers (by using the well-known read-one-write-all scheme).

Note that application software is not counted in the above example because the application software is assumed to be fully duplicated on all the application servers. If required, which might happen frequently, the application software must be installed and set up properly beforehand. This will cause problems same as previous ones.

Therefore, there exists a need to overcome the shortcomings of the traditional thin-client/server model.

### SUMMARY OF THE INVENTION

A novel thin-client/server computing model called multiple-application-server thin-client/server (MAS TC/S) is disclosed in the present invention. The MAS TC/S system provides transparent working environments to thin-client devices while roaming a wide area network (WAN). The MAS TC/S system of the present invention can be applied to a wide variety of applications, such as office automation for transnational corporations and new Internet services.

The MAS TC/S system includes several major components: a display protocol, a multiple-application-server network, an application-server discovery protocol, and a distributed file system. The display protocol follows standard protocol used in traditional, LAN-based thin-client/server architectures such as X, ICA, RDP, and SLIM. The application-server discovery protocol helps the thin-client device to identify the most appropriate application server to connect to. And the distributed file system includes the functionality of traditional distributed file systems with some reinforcements, including an intelligent prefetching mechanism and an appointed prefetching mechanism.

Implementation results show that the MAS TC/S system of the present invention provides a practical infrastructure for service-oriented mobile applications in a WAN.

Advantages and spirit of the present invention can be further understood by the following detailed description of the invention and drawings.

### BRIEF DESCRIPTION OF THE DRAWINGS

FIG. 1 depicts a thin-client/server computing model;

FIG. 2 depicts a MAS TC/S architecture of the present invention;

FIG. 3 depicts a step flow chart of a MAS TC/S process of the present invention;

FIG. 4 depicts a step flow chart of unicast lookup for identifying an appropriate application server;

FIGS. 5a to 5c depict an instance of prefetching based on access patterns;

FIGS. 6a to 6e depict an implementation example of the MAS TC/S system of the present invention; and

FIGS. 7a and 7b depict connection processes of thin-client device and application server.

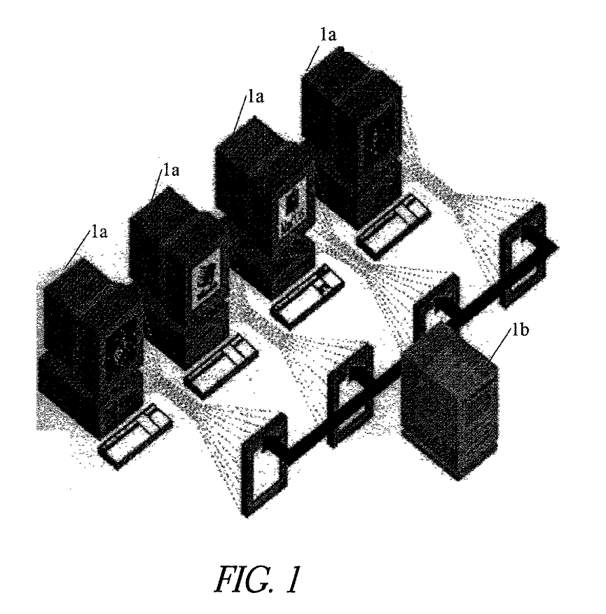

### DETAILED DESCRIPTION OF THE INVENTION

Transparent Working Environment

A distributed system is commonly considered to be transparent when the constituent components are concealed from the user, so that the entire system is perceived as a whole rather than as a collection of independent components. The MAS TC/S system of the present invention provides a transparent working environment so that a user will experience substantially the same working environment no matter which application server in a multiple-application-server network the user connects to. That is, the user will be ignorant of which application server he/she is connecting to while roaming in a wide area network. The user will experience substantially the same working environment even though the user may try to connect to the multiple-application-server network from different location.

The transparent working environment of the MAS TC/S system is mainly accomplished by prefetching a portion, not necessarily all, of a user's data to an appropriate application server that is preferably nearest to the user. Preferably the MAS TC/S system provides a transparent working environment including a user's operation interface that is substantially the same whichever application server in the multiple-application-server network the user connects to. The user's operation interface, such as desktop operation windows and preference setting of application software, is maintained substantially the same so as to provide a familiar working environment to the user; however, slightly difference appearing on the user's operation interface, for example indicating which application server is presently connected on the interface, will not deviate from the definition of transparency working environment herein.

Generally, transparency has the following forms:

Access transparency enables local and remote resources to be accessed using identical operations.

Location transparency enables resources to be accessed without knowledge of their locations.

Mobility transparency allows the movement of resources and clients within a wide area network without affecting the operation of users.

According to the present invention, a user is allowed to log onto a system with the same account and password from different locations in a WAN as well as in a LAN, and work with substantially the same files, applications and their preference setting, and desktop working interface without any manual environment settings and translation, which being referred to as having a transparent working environment.

Examples of systems that are able to maintain a transparent working environment in a LAN include Sun's NFS+NIS, Novell Netware, and Microsoft Windows NT. However, the transparency of their working environments does not apply to a WAN.

The MAS TC/S System

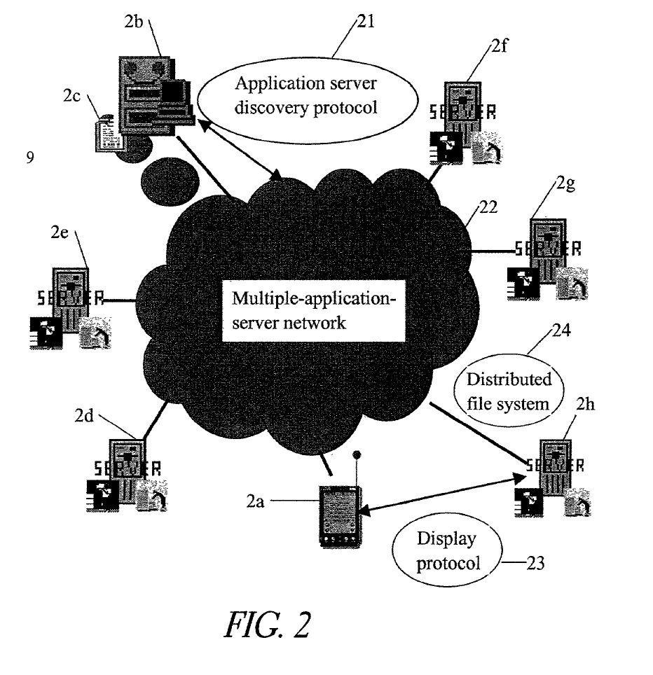

The MAS TC/S system of the present invention includes the following major components, and please refer to FIG. 2 for illustrative description of the MAS TC/S architecture.:

An application-server discovery protocol 21 that allows a thin-client device 2a to identify an appropriate application server in a multiple-application-server network 22.

A display protocol 23 that allows the thin-client device 2a and the application server to communicate.

A distributed file system 24 that provides a transparent working environment such that a user will experience substantially the same working environment no matter which application server in the multiple-application-server network 22 the user connects to.

Please note that these components 21 to 24 are shown in FIG. 2 for illustrative description and may not represent their connections and functions in a definite way.

The display protocol 23 in the MAS TC/S system can be the same as that used in traditional thin-client/server computing model, such as X protocol, independent computing architecture (ICA) protocol, remote desktop (RDP) protocol, and stateless low-level interface machine (SLIM) protocol. Therefore, a thin-client device designed for traditional thin-client/server computing model can also be used for the MAS TC/S system, such as X terminal, SLIM console, ICA's windows-based terminal, personal computer, workstation, TV set top box, personal digital assistant (PDA) or cellular phone.

As shown in FIG. 2, in the multiple-application-server network 22, a plurality of application servers 2d, 2e, 2f, 2g, and 2h are included. The multiple-application-server network 22 may represent a WAN and even the Internet.

A circumstance is assumed to illustrate how the MAS TC/S system works. In FIG. 2, a user is normally connected to the application server 2d for the most efficient and feasible services, and all of the user's data and files are stored in this server 2d. When the user travels to another location particularly outside the LAN to which the application server 2d is linked, the MAS TC/S system works in the following ways.

When the user uses the thin-client device 2a to connect to the multiple-application-server network 22, the application-server discovery protocol 21 helps the thin-client device 2a to find an appropriate application server 2h to connect to. Normally the appropriate application sever 2h is in the same LAN with the thin-client device 2a such that the thin-client device 2a will receive prompt service avoiding constraints of network transmission speeds. In one embodiment, a redirection server 2b equipped with a database 2c that contains information about all available application servers in the multiple-application-server network 22 helps the thin-client device 2a to find the appropriate application server 2h.

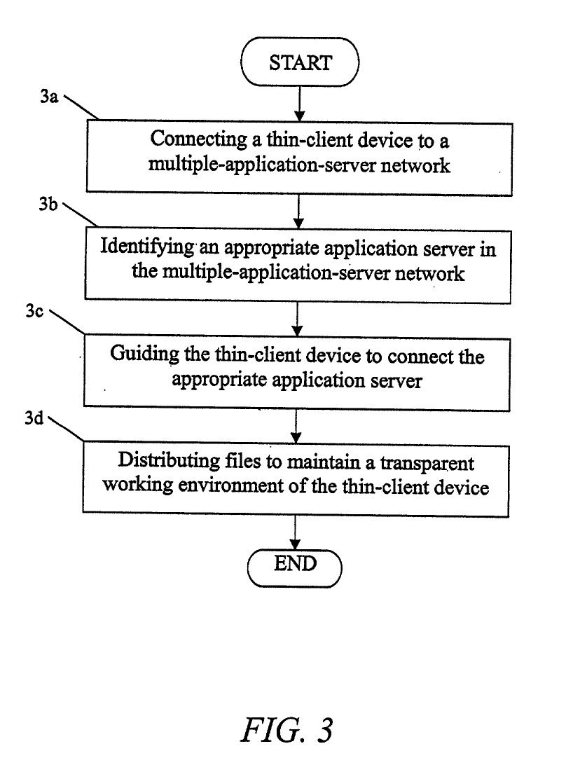

In FIG. 3, a step flow chart of a MAS TC/S process of the present invention is shown. In step 3a, a thin-client device is connected to a multiple-application-server network. In step 3b, an appropriate application server that is the most appropriate one for the thin-client device in the multiple-application-server network is identified. In step 3c, the thin-client device is guided to connect the appropriate application server. And in step 3d, files are distributed to the appropriate application server to maintain a transparent working environment of the thin-client device.

Application-Server Discovery Protocol

When a user tries to connect to an application server by using a thin-client device, the application-server discovery protocol is used to identify the most appropriate application server in the multiple-application-server network. Two kinds of application-server discovery protocols are proposed and implemented in the present invention: (1) multicast discovery protocol: the thin-client device conducts a multicast broadcast for application server with one or more specific group name or default group name; and (2) unicast discovery protocol: each lookup for application server issued by the thin-client device is sent to one or several redirection servers, which being equipped with a database that contains information about all the application servers. The redirection server will inform the thin-client device which is the most appropriate application server and guide the thin-client device to connect to the most appropriate application server according to the location of the thin-client device. Preferably the most appropriate application server is the one nearest to the thin-client device. Furthermore, the redirection server may identify the appropriate application server according to layout and status of application servers in the multiple-application-server network in addition to the location. For example, the loading status of application servers may be considered in determining which is the most appropriate one.

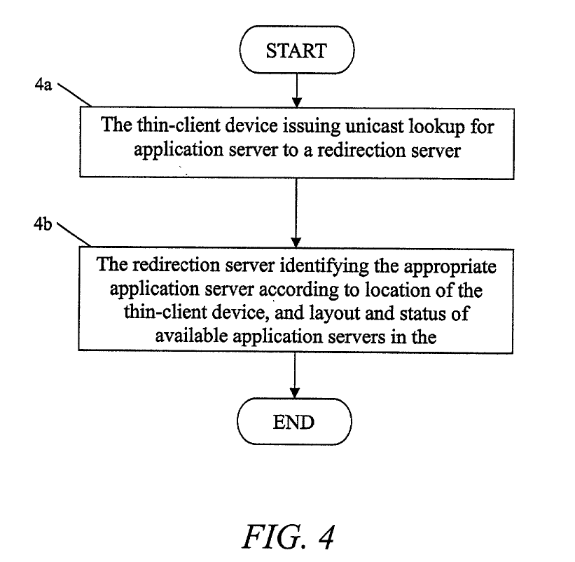

In FIG. 4, a step flow chart of unicast lookup for identifying an appropriate application server is shown. In step 4a, the thin-client device issues unicast lookup for application server to a redirection server; and in step 4b, the redirection server identifies the most appropriate application server according to location of the thin-client device, and layout and status of available application servers in the multiple-application-server network.

Distributed File System for the MAS TC/S System

The distributed file system for the MAS TC/S system is applied in the present invention to achieve a transparent working environment which is preferably with access, location, and mobility transparencies. The potentially large number of application servers installed in a WAN environment means that the storage and communication costs of replicating all users' data or files on all the application servers may be prohibitively high. An efficient distributed file system is indeed very important in the MAS TC/S system and preferably it must possess a file prefetching mechanism that predicts users' data demands. The distributed file system of the present invention includes the functionality of traditional distributed file systems with enhanced mechanisms for file prefetching.

A working environment for a user needs the following types of data:

1. User's records or preferences: This includes the window manager's records and the record files of various applications.

2. User's files: There are personal files that exclusively belong to the user, such as files for e-mail, word processors, spread sheets, graphics, and multimedia.

3. Application software: These are binary codes for various applications.

These three types of data exist in the application server in the form of files. In the remainder of this specification, the term user's data is used to refer collectively to both a user's records and a user's files. To provide the user with a transparent working environment, the required files should be ready after the user logs onto an application server. However, in a WAN, a user could go anywhere and log onto any application server via a thin-client device, and thus an application server should prepare each user's data in order to provide a prompt service.

The distributed file system of the present invention does not require a user's data to be fully replicated on every individual application server. Therefore, a situation that some of user's data may be absent when the user logs onto the appropriate application server should be taken care of. If the user needs some absent file, this connected application server has to fetch it.

In a traditional thin-client/server computing model, an acceptable response time could be obtained as long as the following two requirements are met: (1) the network bandwidth between the thin-client device and the connected application server is fast enough for the display protocol, and (2) the load on the application server is moderate. However, in the MAS TC/S system, since the users' data are not duplicated on all the application servers, the delay associated with fetching absent files must be considered in addition to the above two factors when determining an acceptable response time.

There are two kinds of fetching mechanisms: demand fetching and prefetching mechanisms. The demand fetching commences after a user has requested file access, whereas in prefetching the files are fetched beforehand.

Similar technologies for data fetching can be found in the context of CPU cache and the paging system of operating systems. The granularity of data fetching in CPU cache and the paging system are respectively cache lines and memory pages, whereas application servers fetch files. According to previous work on prefetching technologies in the CPU cache and paging system, prefetching is usually much better than demand fetching in terms of the miss ratio because memory access for ordinary programs is usually sequential.

It is obvious that there are some differences between memory access by the processor and file access by users. First, cache lines and memory pages are usually of fixed size, whereas files are of variable size. Second, files possess some extra information such as creation date, updated time, owner, and type. Two factors are further considered when designing an appropriate prefetching mechanism in the MAS TC/S system: (1) multiple-application-server network, and (2) requirement of a transparent working environment.

Two prefetching mechanisms are included, intelligent prefetching and appointed prefetching, which are further described in the following.

Intelligent Prefetching

The intelligent prefetching mechanism proceeds in parallel with the processing of user's data requests by the application server. Its main mission is to predict a set of data that will be needed by the user after the current data request. User's data in a connection session are classified into the following three categories:

1. System data: This dictates the set of data required by the user's desktop working environment immediately after the user logs on, including record files for window managers, the setups for various applications, and information about home file directory. The system data of a given user is required by the application server for providing the user with his or her proprietary environment.

2. Working data: This refers to the set of files that the user needs to work with during the connection session.

3. Unused data: This represents all the other files not used during the connection session.

It is preferable that both system data and working data of a user session can be fetched before they are actually needed. However, while system data can be determined precisely, it is unlikely that the working data can be determined accurately. Moreover, the size of system data pertaining to a given user is much smaller compared to his working data. The system data size is usually no more than 100 kB, whereas it is quite common that a user possesses files of hundreds or thousands of megabytes under his home directory. Thus demand fetching is often sufficient for system data because system data are usually small and remaining unchanged.

The intelligent prefetching mechanism predicts the set of working data preferably based on historical data obtained in previous connections, including access times, access operations, and sizes of files. Specifically, two approaches are provided:

1. Priority prefetching: This approach lists the files pertaining to a user in some order of priority. The priority measure of a file can be specified as a function of its attributes. For example, files that are accessed frequently and have smaller sizes should have higher priority.

2. Access-pattern-based prefetching: This approach dynamically prefetches files based on the user's current file request and the user's most frequent access patterns. For example, when the user places a request to open a file, a prediction is made with a certain probability which files are subsequently needed. These files are candidates for prefetching.

Several techniques can be applied to intelligent prefetching, such as data mining, neural network, artificial intelligence, and fuzzy techniques. A comprehensive algorithm based on data mining technique is developed in the present invention for the access-pattern-based prefetching, which will be outlined in the following. When it comes to predicting the subsequent file accesses associated with the current one, the application server seeks the answer to the following question: “Find the set of files that may be subsequently accessed within the next ⊖ units of time with at least s% probability, where ⊖ and s are user-specified thresholds.”

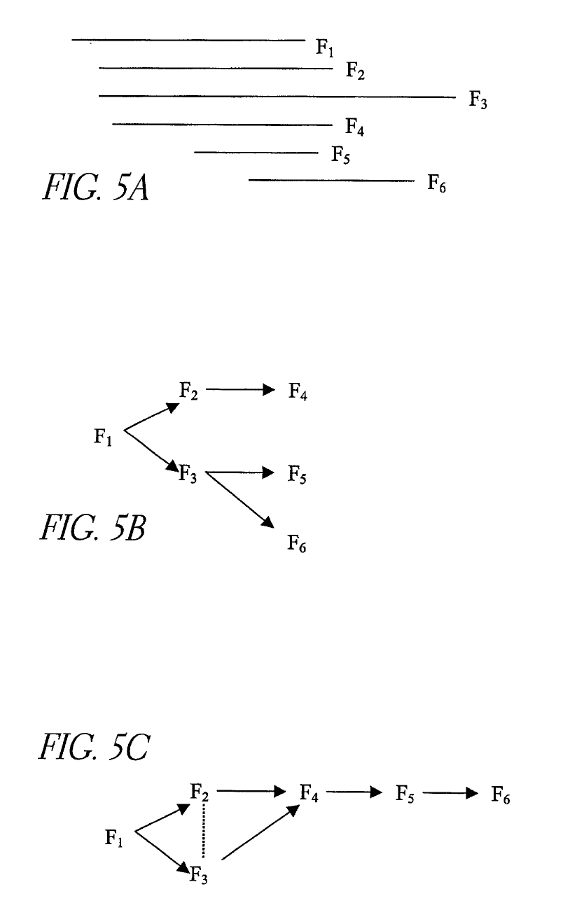

To answer this query, the most frequent patterns of file access need to be kept track of. A file access pattern is represented as a directed acyclic graph with vertices being files, and where (f₁, f₂) is an edge if it is found that the access of f₂ often follows that of f₁ within a short period of time. Such a graph is called a temporal graph. Any pair of files in a temporal graph must obey either a followed or an overlapped temporal relationship. A file f₁ is followed by another file f₂ in a temporal graph if there exists a path that connects f₁ to f₂, and they are overlapped if neither is followed by the other. In fact, a file access instance can also be represented as a temporal graph. For example, consider the file access instance shown in FIG. 5a, where the interval of each file marks its open time and close time in the instance. FIG. 5b shows the invocation relationship of files F₁ to F₆. That is, F₁ invokes F₂ and F₃, and F₃ in turn invokes F₅ and F₆. Since both F₂ and F₃ are invoked by the same file, i.e. F₁, and their open times are very close, F₂ and F₃ are said to be overlapped in this instance. In contrast, F₁ is said to be followed by F₂ because they are not invoked by the same file and the open time of F₁ is before that of F₂. Also, F₅ is said to be followed by F₆ because, although they are invoked by the same file F₃, the open time of F₅ is well before that of F₆. The corresponding temporal graph of this example is shown in FIG. 5c, where the dotted line represents overlapped temporal relationship. Details of discovering frequently observed temporal (sub)graphs from a given file-access history, or mining algorithm, can be found in C. -P. Wei et al (C. -P. Wei, S. -Y. Hwang, W. -S. Yang. Mining Frequent Temporal Patterns in Process Databases; Proc. of the 10^{th} International Workshop on Information Technologies and Systems (WITS00); Brisbane, Australia, 2000).

Each edge (fᵢ,fⱼ) in the temporal graph is associated with a pair of time values (μ,σ) representing distribution of duration between the opening time of fᵢ and that of fⱼ, where μ and σ are the mean and standard derivation, respectively. These time values can be used for calculating the likelihood of subsequently accessing a file within a particular period. For example, if the support of (fᵢ,fⱼ) divided by that of fᵢ is 30%, and the duration follows a normal distribution, we can claim that after the access of fⱼ, there is 30%×84.13% of chance that fⱼ will be accessed within μ+σ units of time, wherein 84.13% is set from P(X≦μ+σ)=Φ(1.0)=0.8413 (X is normally distributed with mean μ and variance σ², and Φ(z)

$$Φ ( z ) = {\int }_{- ∞}^{z} \frac{1}{\sqrt{2 π}} {ⅇ}^{- {u}^{2} / 2} ⅆ u ) .$$

Algorithm 1 hereunder lists the algorithm for identifying a set of files that satisfy the above query.

Algorithm 1: Prefetching algorithm based on access patterns

/* find the set of files that may be subsequently accessed after the current data request fᵢ within the next ⊖ units of time with a probability of at least s%*/

1. Find the set T of temporal graphs with no edges incident on f;

2. Return−Set=Ø

3. For each frequent temporal graph Tᵢ in T:

A. Find the path with the largest value on

$$d = {\sum }_{j is an edge in the path}^{} {μ}_{j} + {σ}_{j} ,$$

where (μⱼ, σⱼ) represents the duration distribution associated with the j'th edge. If d>⊖, continue with the next temporal graph;

B. Find the longest path. Let the path length be l and the supports of f and Tᵢ be s₁ and s₂, respectively. If s₁/s₂×(84.13%)<s, continue with the next temporal graph

C. Add the files in Tᵢ to Return−Set;

4. Return Return−Set

Note that the above algorithm is for a limited number of frequent temporal graphs.

One may tend to set a large value for ⊖ and a small one for s, which would result in the prefetching of many files, and therefore the subsequently accessed files are more likely to be included. However, a substantial amount of file transfers may degrade the network performance so that more recently needed files may not arrive in time. A tradeoff is expected between the settings of ⊖ and s.

The most common file access patterns can also be used for determining replaced files. The answer to the following query is of concern: “Find the set S₂ of files that may be subsequently accessed within the next ⊖₂ units of time with the probability

$${s}_{2} \% {.}^{”}$$

S₂ contains the files that are likely to be accessed in a sufficiently long period of time ⊖₂. The cached files that do not belong to S₂ are candidates for replacement. Since S₂ is the set of files intended for replacement, the setting of ⊖₂ and s₂ could be significantly larger than and smaller than that of ⊖ and s, respectively, in the previous query. A straightforward algorithm for processing the above query can be derived in a similar way to Algorithm 1.

Appointed Prefetching

In addition to the intelligent prefetching, in which the system attempts to determine the file access patterns that frequently appear in the user's routine schedules, another prefetching mechanism—called appointed prefetching—is also provided to catch a user's irregular schedules. The appointed prefetching mechanism specifies at least one file which is needed by the user and the specified file is transmitted to an appropriate application server in advance. In one embodiment, user's schedules are described as a workflow model with a focus on their dataflow. Specifically, a schedule is modeled as a set of tasks, and each task is a triplet (D, L, Fs), where D and L specify respectively the durations and locations in which this task will be conducted, and Fs is a set of files needed by the task.

Consider the following example: Peter works in a company located in California and is going to travel to Japan to make a presentation at the R&D department of his company located in Tokyo. During his presentation, he will use the following files: pre1.doc, pre1.ppt, and pre1.scr. Instead of bringing them to Japan, he only specifies a task presentation ((2002/2/30:9:00˜2002/2/30:12:00), Japan R&D, (pre1.doc, pre1.ppt, pre1.scr)) beforehand. The system will transfer these files to the application server in the Japanese R&D department prior to his presentation in Tokyo.

Just as in the intelligent prefetching, the schedules specified by appointed prefetching can be used for both prefetching and replacement. By considering the sizes of the needed files, the time and place a task is planned to take place, and the bandwidth of the network, the system decides a schedule of lowest cost for transferring files under the constraint that the files must arrive at the correct location before the task is actually conducted. Once the time of the performance of a task has passed, these files may become candidates for replacement.

Implementation

A non-disclosed prototype of the MAS TC/S system is built. This prototype spans campuses of three universities located in different cities of Taiwan: National Taiwan Normal University in Taipei (in northern Taiwan), National Tsing-Hua University in Hsinchu (in central Taiwan), and National Sun Yat-Sen University in Kaohsiung (in southern Taiwan). The networking systems of the three universities constitute a WAN.

The application servers are executed on Pentium PCs running Linux OS, and since each Linux workstation is equipped with a built-in X protocol, this was chosen as display protocol. As for thin-client devices, three types of platforms are considered:

Thin-client device type 1: General-purpose PCs or workstations with built-in X protocol and Web browsers.

Thin-client device type 2: PDAs with built-in X protocol and Web browsers.

Thin-client device type 3: Any other computers with a Web browser being capable of executing Java JDK 1.3 applets. These do not need a built-in X protocol.

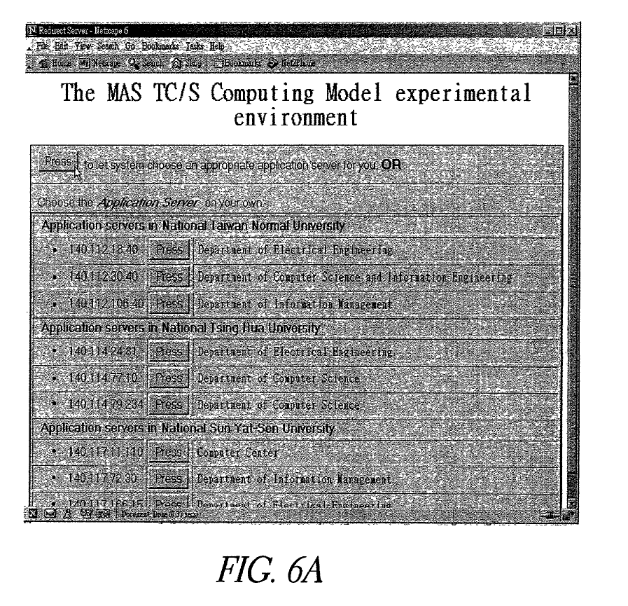

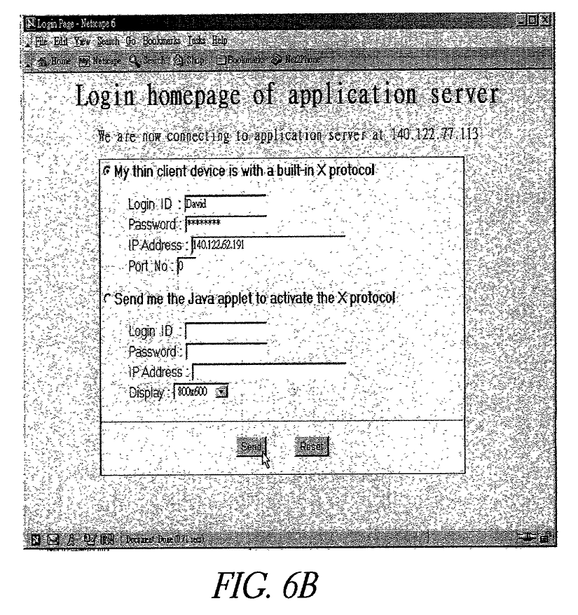

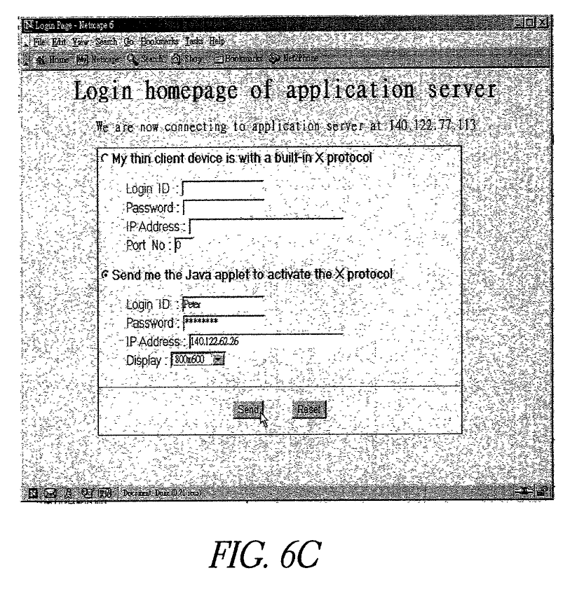

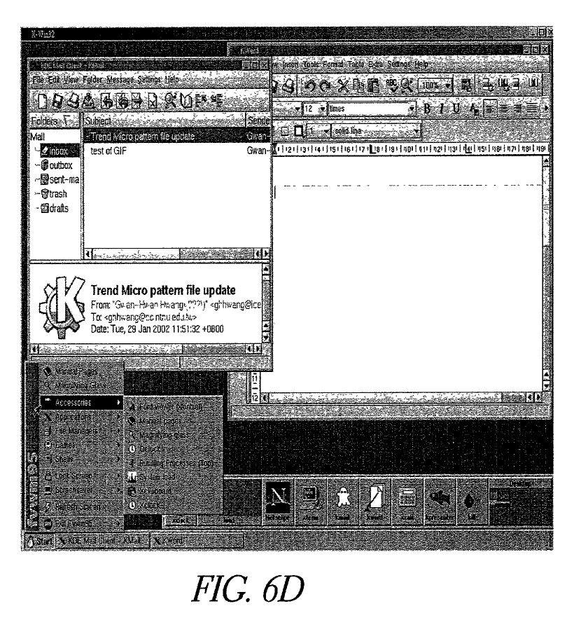

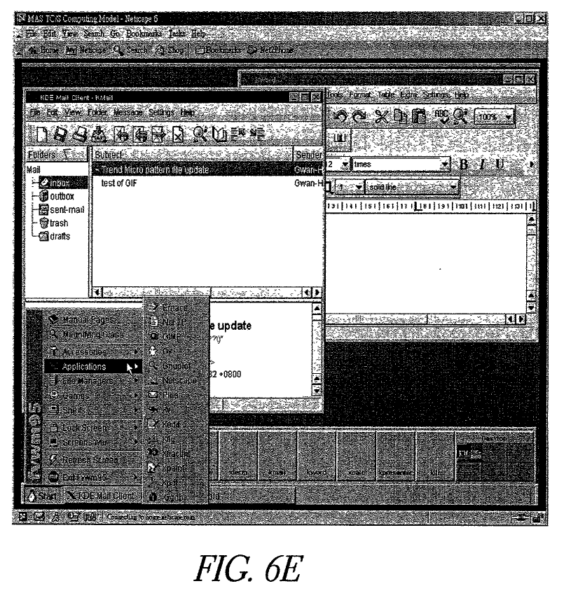

All these three kinds of thin-client devices are equipped with Web browsers since a Web server is used to implement unicast application-server discovery protocol. A redirection server is associated with a database that contains information about all the installed application servers. Once a thin-client device is trying to make a connection to an application server, it first visits home page of the redirection server with its Web browser. As shown in FIG. 6a, all the installed application servers are listed, and the user may either choose one application server on her/his own or let the system choose an appropriate one for him or her.

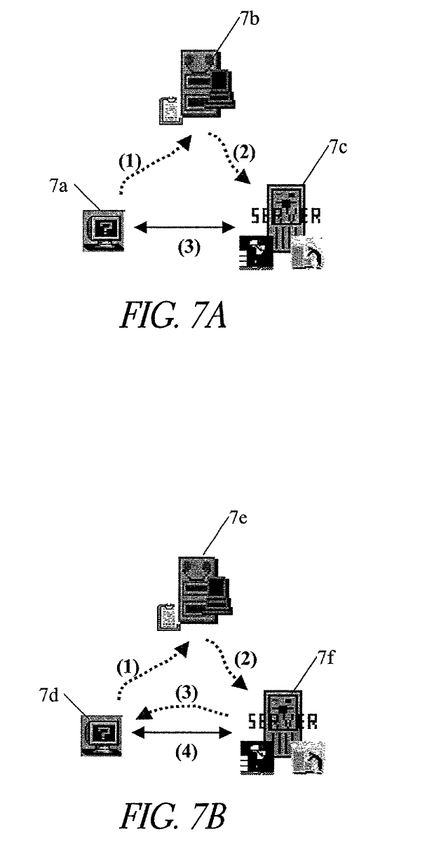

The connection process between a thin client and an application server is depicted in FIGS. 7a and 7b. FIG. 7a shows the connection process for a thin-client device of type 1 or 2 (i.e., which has a built-in X protocol). Firstly, in step (1), a thin-client device 7a visits the home page of a direction server 7b (a screenshot is shown in FIG. 6a). Secondly, in step (2), the redirection server 7b redirects the thin client device 7a to the chosen application server 7c with a login home page, and the user clicks on the radio button to let the application server 7c know that it has a built-in X protocol (a screenshot is shown in FIG. 6b). Finally, in step (3), the application server 7c executes appropriate window manager that uses X protocol to communicate with the user's thin-client device 7a.

FIG. 7b shows the connection process for a thin-client device 7d of type 3. In steps (1) and (2), a redirection server 7e redirects the thin-client device 7d to the chosen application server 7f, which are substantially the same as those steps shown in FIG. 5a except that the thin-client device 7d is of type 3 and hence does not install X protocol. The user indicates this to the application server 7f (a screenshot is shown in FIG. 6c). Then, in step (3), the application server 7f sends an Java applet called Xweird that emulates the X protocol. FIG. 6d shows a screenshot of an operational thin-client with a build-in X protocol, and FIG. 6e shows a screenshot of an operational thin-client that connects to an application server with a Web browser executing the Xweird Java applet.

The MAS TC/S system of the present invention can be applied to a wide variety of applications, such as service-oriented infrastructure for Internet service providers, and office automation for transnational corporations.

The above detailed description is to clearly describe features and spirit of the present invention and is not intended to limit the scope of the present invention. Various changes and equivalent modifications should be covered by the invention. Therefore, the scope of the present invention should be interpreted based on the following claims together with the above descriptions in the broadest way.

What is claimed is:

1. A process for roaming thin-clients in a wide area network, comprising the steps of:
connecting a thin-client device to a multiple-application-server network;
identifying an appropriate application server in the multiple-application-server network;
guiding the thin-client device to connect the appropriate application server; and
prefetching a user's data to the appropriate application server for providing a transparent working environment so that the user will experience substantially the same working environment no matter to which application server in the multiple-application-server network the user connects.

2. The process of claim 1, wherein the step of identifying the appropriate application server is accomplished by the thin-client device conducting a multicast broadcast for application server.

3. The process of claim 1, wherein the step of identifying the appropriate application server comprises the steps of:
the thin-client device issuing unicast lookup for appropriate application server to a redirection server; and
the redirection server identifying the appropriate application server.

4. The process of claim 3, wherein the redirection server identifies the appropriate application server according to location of the thin-client device.

5. The process of claim 3, wherein the redirection server identifies the appropriate application server according to layout and status of application servers in the multiple-application-server network.

6. The process of claim 1, wherein the step of prefetching comprises an intelligent prefetching step.

7. The process of claim 1, wherein the step of prefetching comprises an appointed prefetching step.

8. The process of claim 6, wherein the step of intelligent prefetching is accomplished based on a priority prefetching approach.

9. The process of claim 6, wherein the step of intelligent prefetching is accomplished based on a user's access pattern.

10. The process of claim 1, wherein the thin-client device is an X terminal, a SLIM console, an ICA's windows-based terminal, a personal computer, a workstation, a TV set top box, a personal digital assistant, or a cellular phone.

11. A multiple-application-server thin-client/server system, comprising:
an application-server discovery protocol allowing a thin-client device to identify an appropriate application server in a multiple-application-server network;
a display protocol allowing the thin-client device and the application server to communicate; and
a distributed file system providing a transparent working environment; whereby a user will experience substantially the same working environment no matter to which application server in the multiple-application-server network the user connects.

12. The system of claim 11, wherein the application-server discovery protocol is a multicast discovery protocol in which the thin-client device conducts a multicast broadcast for application server.

13. The system of claim 11, wherein the application-server discovery protocol is a unicast discovery protocol in which each lookup of application server issued by the thin-client device is sent to a redirection server.

14. The system of claim 13, wherein the redirection server is equipped with a database containing information about application servers in the multiple-application-server network.

15. The system of claim 13, wherein the redirection server identifies the appropriate application server according to location of the thin-client device.

16. The system of claim 13, wherein the redirection server identifies the appropriate application server according to layout and status of application servers in the multiple-application-server network, and guides the thin-client device to connect to the appropriate application server.

17. The system of claim 11, wherein the distributed file system comprises a prefetching mechanism.

18. The system of claim 17, wherein the prefetching mechanism comprises an intelligent prefetching mechanism.

19. The system of claim 17, wherein the prefetching mechanism comprises an appointed prefetching mechanism.

20. The system of claim 18, wherein the intelligent prefetching mechanism comprises a priority prefetching mechanism.

21. The system of claim 18, wherein the intelligent prefetching mechanism comprises an access-pattern-based prefetching mechanism.

22. The system of claim 20, wherein the priority prefetching mechanism determines prefetching priority according to access frequency and size of files.

23. The system of claim 21, wherein the access-pattern-based prefetching mechanism predicts subsequent file accesses according to prior file accessing pattern.

24. The system of claim 19, wherein the appointed prefetching mechanism specifies at least one file to be transmitted.

25. The system of claim 19, wherein the appointed prefetching mechanism specifies a task including duration and location in which the task will be conducted, and including at least a file needed by the task.

26. The system of claim 11, wherein the thin-client device is an X terminal, a SLIM console, an ICA's windows-based terminal, a personal computer, a workstation, a TV set top box, a personal digital assistant, or a cellular phone.

27. The system of claim 11, wherein the display protocol is X protocol, ICA protocol, remote desktop protocol or SLIM protocol.
